(19) United States
(12) Patent Application Publication
(10) Pub. No.: US 2026/0222124 A1
(43) Pub. Date: Jul. 30, 2026

(54) DEVICE AND METHOD FOR TRANSMITTING DATA WITH LOW LATENCY IN WIRELESS LOCAL AREA NETWORK

(71) Applicant: FRONTSIDE LLC, Seoul (KR)

(72) Inventor: Jeong Soo LEE, Gyeonggi-do (KR)

(21) Appl. No.: 19/143,034

(22) PCT Filed: Dec. 21, 2023
(86) PCT No.: PCT/KR2023/021271

§ 371 Date: Jun. 25, 2025

(30) Foreign Application Priority Data
Dec. 26, 2022 (KR) 10-2022-0184189
Feb. 13, 2023 (KR) 10-2023-0018782
Jul. 31, 2023 (KR) 10-2023-0099754

(51) Int. Cl. H04L 1/1829; H04W 28/02; H04W 74/0808; H04W 76/15; H04W 84/12

(52) U.S. Cl. CPC H04L 1/1864; H04W 28/0278; H04W 74/0808; H04W 76/15; H04W 84/12

(57) ABSTRACT

A second station which is a transmission opportunity (TXOP) responder receives date from a first station which is a TXOP holder. The second station transmits a BlockAck (BA) frame to acknowledge the data within a TXOP to the first station. The BA frame includes low latency (LL) indication information indicating that the second station has an LL packet intended for the first station.

### TECHNICAL FIELD

The present disclosure relates to a wireless local area network (WLAN), and more particularly, to a method for transmitting data with low latency in the WLAN and a device using the same.

### BACKGROUND ART

A wireless local area network (WLAN) may be formed by one or more access points (APs) that provide a shared wireless communication medium for use by a number of client devices also referred to as stations (STAs).

Orthogonal frequency division multiple access (OFDMA) is a multiple access scheme where different subsets of subcarriers are allocated to different users, and this scheme allows simultaneous data transmission to or from one or more users.

A physical layer protocol data unit (PPDU) is a data unit (or data packet) to carry various information in the WLAN. In OFDMA, users are allocated different subsets of subcarriers that can change from one PPDU to the next. Using OFDMA, an AP may allocate different RUs for STAs. The AP can simultaneously transmit various formats of PPDUs to multiple STAs.

Latency may be the time that elapses between a user request and the completion of that request. Low latency data transfer generally requires to optimize to process data messages with minimal delay.

A default channel access mechanism used in current WLAN systems is referred to as enhanced distributed channel access (EDCA). In the EDCA channel access mechanism, the STA accesses the channel using a set of channel access parameters based on a traffic class of the data. The channel is obtained for a transmission opportunity (TXOP), in which multiple frames of the same data class may be transmitted. The maximum size of the TXOP depends on the data type. The low latency traffic cannot be sent once a TXOP has already started.

### DISCLOSURE OF INVENTION

### Technical Problem

The present disclosure provides a method for transmitting data in a wireless local area network.

The present disclosure further provides a device for transmitting data in a wireless local area network.

### Solution to Problem

In an aspect, a method for transmitting data in a wireless local area network is provided. The method is performed by a second station which is a transmission opportunity (TXOP) responder. The method includes receiving, from a first station which is a TXOP holder, data, and transmitting, to the first station, a BlockAck (BA) frame to acknowledge the data within a TXOP. The BA frame includes low latency (LL) indication information indicating that the second station has an LL packet intended for the first station.

in another aspect, a device for a wireless local area network includes a processor, and a memory operatively coupled with the processor and configured to store instructions that, when executed by the processor, cause the device to perform functions. The functions include receiving, from a station which is a transmission opportunity (TXOP holder), data, and transmitting, to the station, a BlockAck (BA) frame to acknowledge the data within a TXOP. The BA frame includes low latency (LL) indication information indicating that the device has an LL packet intended for the station.

### Advantageous Effects of Invention

As new WLAN communication protocols enable enhanced features, new PPDU transmission designs are provided to support signaling regarding features and resource allocations.

### BRIEF DESCRIPTION OF DRAWINGS

FIG. 1 shows a block diagram of an example wireless communication network.

FIG. 2 shows a block diagram of an example wireless communication device.

FIG. 3 shows an example of UL MU transmission.

FIG. 4 shows an example of multi-link operation.

FIG. 5 shows an example of an enhanced multi-link single radio operation.

FIG. 6 shows an example of contents in EML Operating Mode Notification frame.

FIG. 7 shows an example illustrating problems that may occur in conventional WLAN.

FIG. 8 shows an example of packet transmission according to an embodiment of the present disclosure.

FIG. 9 shows an example of initial control frame format according to an embodiment of the present disclosure.

FIG. 10 shows an example of packet transmission according to another embodiment of the present disclosure.

FIG. 11 shows an example of BlockAck frame format according to an embodiment of the present disclosure.

FIG. 12 shows an example of packet transmission according to still another embodiment of the present disclosure.

FIG. 13 shows an example when multiple SU PPDU transmission is granted.

FIG. 14 shows another example when multiple SU PPDU transmission is granted.

FIG. 15 shows still another example when multiple SU PPDU transmission is granted.

FIG. 16 shows an example of packet transmission according to an embodiment of the present disclosure.

FIG. 17 shows an example of QoS Characteristics element format.

FIG. 18 shows an example of packet transmission according to another embodiment of the present disclosure.

FIG. 19 shows an example of packet transmission according to still another embodiment of the present disclosure.

FIG. 20 shows an example of packet transmission according to still another embodiment of the present disclosure.

FIG. 21 shows an example of CCMP MPDU format.

FIG. 22 shows an example of Head-of-line (HOL) blocking issue.

FIG. 23 shows MAC frame format to classify LL MPDU according to an embodiment of the present disclosure.

FIG. 24 shows an example of constructing A-MPDU for LL application.

FIG. 25 shows an example of constructing A-MPDU for LL application according to an embodiment of the present disclosure.

FIG. 26 shows an example of constructing A-MPDU for LL application.

### MODE FOR THE INVENTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

OFDMA is an OFDM-based multiple access scheme where different subsets of subcarriers are allocated to different users, and this scheme allows simultaneous data transmission to or from one or more users. In OFDMA, users are allocated different subsets of subcarriers that can change from one PPDU to the next. Similar to OFDM, OFDMA employs multiple subcarriers, but the subcarriers are divided into several groups where each group is referred to as a resource unit (RU).

A physical layer protocol data unit (PPDU) may span one or more subchannels and may include a preamble portion and a data portion. Signaling refers to control fields or information in the preamble portion that can be used by a wireless communication device to interpret another field or portion of the preamble portion or the data portion of the PPDU. A wireless channel may be formed from multiple subchannels. A subchannel may include a set of subcarriers. Portions of the wireless channel bandwidth can be divided or grouped to form different resource units (RUs). An RU may be a unit for resource allocation and may include one or more subcarriers. Among other things, a preamble portion of a PPDU may include signaling to indicate which RUs are allocated to different devices. Other types of signaling include indicators regarding which subchannels include further signaling or which subchannels may be punctured. There are several formats of PPDUs (and related structures) defined for current wireless communication protocols. As new wireless communication protocols enable enhanced features, new preamble designs are needed support signaling regarding features and resource allocations. Furthermore, it desirable to define a new preamble signaling protocol that can support future wireless communication protocols.

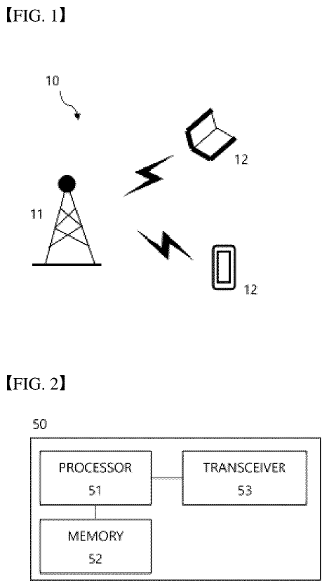

FIG. 1 shows a block diagram of an example wireless communication network. According to some aspects, the wireless communication network 10 can be an example of a wireless local area network (WLAN) such as a Wi-Fi network (and will hereinafter be referred to as WLAN 10). For example, the WLAN 10 can be a network implementing at least one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). The WLAN 10 may include numerous wireless communication devices such as an access point (AP) 11 and multiple stations (STAs) 12. While only one AP 11 is shown, the WLAN network 10 also can include multiple APs.

Each of the STAs 12 also may be referred to as a mobile station (MS), a mobile device, a mobile handset, a wireless handset, an access terminal (AT), a user equipment (UE), a subscriber station (SS), or a subscriber unit, among other possibilities. The STAs 12 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 11 and an associated set of STAs 12 may be referred to as a basic service set (BSS), which is managed by the respective AP 11. The BSS may be identified to users by a service set identifier (SSID), as well as to other devices by a basic service set identifier (BSSID), which may be a medium access control (MAC) address of the AP 11. The AP 11 periodically broadcasts beacon frames (“beacons”) including the BSSID to enable any STAs 12 within wireless range of the AP 11 to “associate” or re-associate with the AP 11 to establish a respective communication link (hereinafter also referred to as a “Wi-Fi link”), or to maintain a communication link, with the AP 11. For example, the beacons can include an identification of a primary channel used by the respective AP 11 as well as a timing synchronization function for establishing or maintaining timing synchronization with the AP 11. The AP 11 may provide access to external networks to various STAs 12 in the WLAN via respective communication link.

To establish a communication link with an AP 11, each of the STAs 12 is configured to perform passive or active scanning operations (“scans”) on frequency channels in one or more frequency bands (for example, the 2.4 GHz, 5 GHZ, 6 GHz or 60 GHz bands). To perform passive scanning, a STA 12 listens for beacons, which are transmitted by respective APs 11 at a periodic time interval referred to as the target beacon transmission time (TBTT) (measured in time units (TUs) where one TU may be equal to 1024 microseconds (μs)). To perform active scanning, a STA 12 generates and sequentially transmits probe requests on each channel to be scanned and listens for probe responses from APs 11. Each STA 12 may be configured to identify or select an AP 11 with which to associate based on the scanning information obtained through the passive or active scans, and to perform authentication and association operations to establish a communication link with the selected AP 11. The AP 11 assigns an association identifier (AID) to the STA 12 at the culmination of the association operations, which the AP 11 uses to track the STA 104.

In some cases, STAs 12 may form networks without APs 11 or other equipment other than the STA. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 10. In such implementations, while the STAs 12 may be capable of communicating with each other through the AP 11 using communication links, STAs 12 also can communicate directly with each other via direct wireless links. Additionally, two STAs 12 may communicate via a direct communication link regardless of whether both STAs 12 are associated with and served by the same AP 11. In such an ad hoc system, one or more of the STAs 12 may assume the role filled by the AP 11 in a BSS. Such a STA may be referred to as a group owner (GO) and may coordinate transmissions within the ad hoc network.

The AP 11 and STAs 12 may function and communicate (via the respective communication links) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and medium access control (MAC) layers. The AP 11 and STAs 12 transmit and receive wireless communications (hereinafter also referred to as “Wi-Fi communications”) to and from one another in the form of PPDUs. The AP 11 and STAs 12 in the WLAN 10 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the AP 11 and STAs 12 described herein also may communicate in other frequency bands, such as the 6 GHz band, which may support both licensed and unlicensed communications. The AP 11 and STAs 12 also can be configured to communicate over other frequency bands such as shared licensed frequency bands, where multiple operators may have a license to operate in the same or overlapping frequency band or bands.

Each of the frequency bands may include multiple channels (which may be used as subchannels of a larger bandwidth channel). For example, PPDUs conforming to the IEEE 802.11n, 802.11ac and 802.11ax standard may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels (which may be referred to as subchannels).

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a first portion (or “legacy preamble”) and a second portion (or “non-legacy preamble”). The first portion may be used for packet detection, automatic gain control and channel estimation, among other uses. The first portion also may generally be used to maintain compatibility with legacy devices as well as non-legacy devices. The format of, coding of, and information provided in the second portion of the preamble is based on the particular IEEE 802.11 protocol to be used to transmit the payload.

Uplink (UL) means that the signal (or message or PPDU) is transmitted by a STA to an AP, and downlink (DL) means that the signal (or message or PPDU) is transmitted by the AP to one or more STAs.

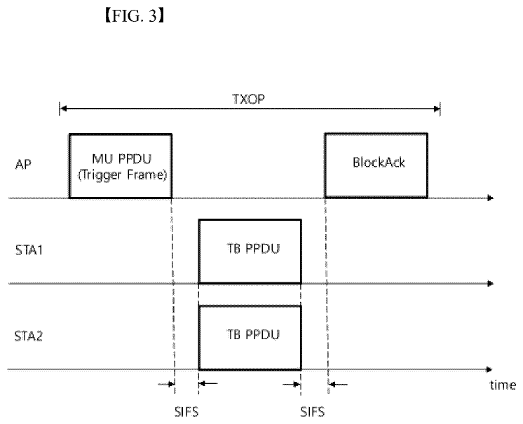

FIG. 2 shows a block diagram of an example wireless communication device.

In some implementations, the wireless communication device 50 can be an example of a device for use in a STA such as one of the STAs 12 described above with reference to FIG. 1. In some implementations, the wireless communication device 50 can be an example of a device for use in an AP such as the AP 11 described above with reference to FIG. 1. The wireless communication device 50 is capable of transmitting (or outputting for transmission) and receiving wireless communications (for example, in the form of wireless packets). For example, the wireless communication device can be configured to transmit and receive packets in the form of PPDUs and/or medium access control (MAC) protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 50 can be, or can include, a chip, system on chip (SoC), chipset, package or device that includes one or more processor 51. The processor 51 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 51 processes information received through a transceiver 53, and processes information to be output through the transceiver 53 through the wireless medium. For example, the processor 806 may implement a physical (PHY) layer and/or a MAC layer configured to perform various operations related to the generation and transmission of PPDUs, MPDUs, frames or packets.

A memory 52 can include tangible storage media such as random-access memory (RAM) or read-only memory (ROM), or combinations thereof. The memory 808 also can store non-transitory processor- or computer-executable software code containing instructions that, when executed by the processor 51, cause the wireless communication device 50 to perform various operations described herein for wireless communication, including the generation, transmission, reception and interpretation of PPDUs, MPDUs, frames or packets. For example, various functions of components disclosed herein, or various blocks or steps of a method, operation, process or algorithm disclosed herein, can be implemented as one or more modules of one or more computer programs.

The transceiver 53 generally includes at least one radio frequency (RF) transmitter (or “transmitter chain”) for transmitting radio signals and at least one RF receiver (or “receiver chain”) for receiving radio signals. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 50 can include, or be coupled with, multiple transmit antennas (each with a corresponding transmit chain) and multiple receive antennas (each with a corresponding receive chain).

Very high throughput (VHT) is used to represent IEEE 802.11ac, high efficiency (HE) is used to represent IEEE 802.11ax, extremely high throughput (EHT) is used to represent IEEE 802.11be. EHT STA may be used to represent a STA supporting at least EHT. EHT STA can further support VHT and/or HE.

Ultra High Reliability (UHR) is used to represent any later (post-EHT) version of a new wireless communication protocol conforming to a future IEEE 802.11 wireless communication protocol standard or other standard, and is for illustration purpose only. ‘UHR’ may be referred to as other terms, for example, Ultra Low Latency (ULL), High Reliability (HR), etc. The UHR PPDU may support future amendments to the IEEE 802.11 wireless communication standard.

FIG. 3 shows an example of UL MU transmission.

UL MU operation allows an AP to solicit simultaneous immediate response frames from one or more STAs.

The AP may send a trigger frame to one or more STAs (for example, STA1 and STA2). The trigger frame may be sent as MU PPDU (for example, HE MU PPDU or EHT MU PPDU). The STA1 and STA2 may send response PDUs (for example, HE TB PPDU or EHT TB PPDU) in response to the trigger frame. The interframe space between a PPDU that contains a triggering frame and the TB PPDU is a Short Interframe Space (SIFS). The AP sends an Ack or BlockAck frame acknowledging the one or more TB PPDUs to the response STAs (for example, STA1 and STA2).

The trigger frame allocates resources for and solicits one or more PPDU transmissions. The trigger frame also carries other information required by the responding STA to send a TB PPDU or a non-HT PPDU. The trigger frame may be sent as various types such as a basic trigger frame, multi-user request to send (MU-RTS) frame, multiuser block ack request (MU-BAR) frame, Beamforming Report Poll (BFRP) Trigger frame, etc.

The trigger frame may include a UL bandwidth field, an CS required field, one or more STA IDs and one or more resource unit (RU) Allocation field. The UL bandwidth field indicates the bandwidth of the response PPDU. The CS required field indicate whether the response STAs are required to use energy detection (ED) to sense the medium and to consider the medium state and the network allocation vector (NAV) in determining whether or not to respond. The one or more STA IDs identifies the one or more response STAs. The RU Allocation subfield indicates RU allocation for the response PPDU.

A NAV is an indicator, maintained by each STA, of time periods when transmission onto the wireless medium (WM) is not initiated by the STA regardless of whether the STA's clear channel assessment (CCA) function senses that the WM is busy. Transmission opportunity (TXOP) is an interval of time during which a particular STA has the right to initiate frame exchange sequences onto the WM.

A WLAN device classify a received PPDU as an inter-PPDU if (i) the received PPDU is transmitted by an AP which is not associated with the WLAN device, (ii) the received PPDU's BSS is not the BSS of the WLAN device, or (iii) the received PPDU is a downlink MU PPDU and the WLAN device is an AP.

A WLAN device classify a received PPDU as an intra-PPDU if (i) the received PPDU is transmitted by an AP which is associated with the WLAN device, (ii) the received PPDU's BSS is the BSS of the WLAN device, or (iii) the received PPDU is a downlink MU PPDU and the WLAN device is an AP.

Timing synchronization function (TSF) keeps TSF timers for all stations in the same BSS synchronized. STAs can maintain a local TSF timer. Each STA can maintain a TSF timer with modulus 264 counting in increments of microseconds. The AP is the timing master for the TSF. The AP can periodically transmit beacon frames which contain the value of the AP's TSF timer in order to synchronize the TSF timers of other STAs in a BSS. A receiving STA can accept the timing information in the beacon frames and can update the receiving STA's TSF timer. If the receiving STA's TSF timer is different from the timestamp in the received beacon frame, the receiving STA can set its local TSF timer to the received timestamp value.

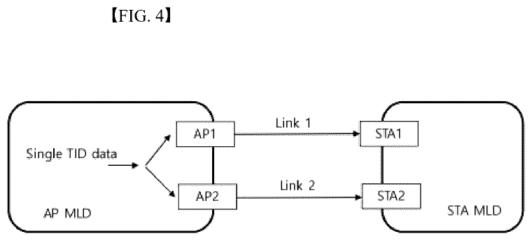

FIG. 4 shows an example of multi-link operation.

In order to optimize the system spectrum utilization and achieve better throughput performance, the IEEE 802.11be has defined multi-link operation (MLO) to support sending data frames concurrently on multiple links. MLO allows the users to enjoy the multilink benefits unavailable for a simple noncontiguous wide spectrum on a single link, such as asynchronous channel access and enhanced power save. The MLO can aggregate a various number of links of different widths. For example, Link1 has a bandwidth of 160 MHz and Link2 has a bandwidth of 40 MHz. Despite having multiple PHY/MAC interfaces, MLD has a single MAC address and uses this MAC address as its own identity. MLO enables frame transmission and retransmission on any link regardless of the link of the initial transmission of the frame.

A multi-link device (MLD) may be a logical entity that is capable of supporting more than one affiliated STA and can operate using one or more affiliated STAs, and that presents one medium access control (MAC) data service and a single MAC-service access point (SAP) to the logical link control (LLC) sublayer. An affiliated AP is an affiliated STA that is an AP STA and the corresponding MLD is an AP MLD. An affiliated STA is a STA, which can be an AP STA or non-AP STA, that provides link-specific, lower MAC and physical layer (PHY) services within an MLD.

An enabled link is a setup link of a non-AP MLD to which at least one traffic identifier (TID) is mapped either in downlink or in uplink. A disabled link is a setup link of a non-AP MLD to which no TID is mapped neither in downlink nor in uplink. A TID is any of the identifiers usable by higher layer entities to distinguish MAC service data units (MSDUs) to MAC entities that support quality of service (QoS) within the MAC data service.

If an MLD implements multiple radios and uses these multiple radios concurrently for the MLO, these devices are defined as multilink multiradio (MLMR) MLD. If an MLD only implements single radio and still wants to operate multiple links, then these devices are called multilink single-radio (MLSR) MLD.

An AP MLD may include multiple APs each capable of communicating on multiple communication links and may establish a BSS on the multiple communication links. A STA MLD may include multiple STAs capable of communicating with other devices (such as an AP MLD) on multiple communication links. If congestion on a first communication link is above a certain level, the MLDs may switch from communicating on the first communication link to communicating on a second communication link. In some implementations, associating with one another on one communication link allows the MLDs to use the same association configuration, encryption keys, and other ML communication parameters when communicating on one or more of the other communication links associated with the MLDs.

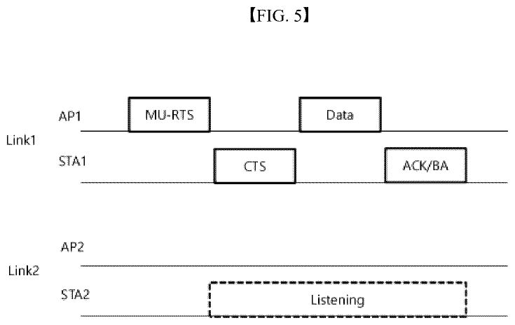

FIG. 5 shows an example of an enhanced multi-link single radio operation.

Enhanced multi-link single radio (EMLSR) operation is a mode of operation that allows a non-AP MLD with multiple receive chains to listen on a set of enabled links when the corresponding STAs affiliated with the non-AP MLD are in the awake state for an initial Control frame (for example, a trigger frame sent by an AP affiliated with an AP MLD, followed by frame exchanges on the link on which the initial Control frame was received).

Assuming that AP MLD includes AP1 and AP2 as affiliated APs, and STA MLD includes STA1 and STA2 as affiliated STAs. When an AP MLD intends to conduct EMLSR operation with an EMLSR STA MLD, each AP within the AP MLD tries to access the corresponding band/channel by running EDCA function independently. In this example, AP1 of the AP MLD is operating on the 6 GHz band (Link1) and AP2 is operating on the 5 GHz band (Link2). If the EDCA function completes the backoff procedure, the corresponding AP starts frame exchange procedure by sending Initial Control Frame (ICF). In this example, AP1 on the 6 GHz band completes backoff, so AP1 sends a MU-RTS frame to start EMLSR operation. When AP1 on the 6 GHz band sends out MU-RTS, STA1 of STA MLD receives the MU-RTS and understands the following DL data transmission which will be carried out on the 6 GHz band.

EMLSR operation can provide throughput enhancement and latency reduction similar to that of concurrent dual-radio MLDs. EMLSR operation enables a wireless device having a single radio to receive data using multiple channels/links. When a wireless device is operating in the EMLSR mode with an AP that supports the EMLSR mode, the device can listen on the enabled links by leaving its affiliated wireless STAs corresponding to those links in an awake state (“listening mode”). The listening operation can include performing clear channel assessment (CCA) and receiving an initial control frame of a frame exchange sequence that is initiated by an AP MLD.

A non-AP MLD may operate in the EMLSR mode on a specified set of the enabled links between the non-AP MLD and its associated AP MLD. The specified set of the enabled links in which the EMLSR mode is applied is called EMLSR links. The EMLSR links can be indicated in the EMLSR Link Bitmap subfield of the EML Control field of the EML Operating Mode Notification frame by setting the bit positions of the EMLSR Link Bitmap subfield to 1. For the EMLSR mode enabled in a single-radio non-AP MLD, the STA(s) affiliated with the non-AP MLD that operates on the link(s) that corresponds to the bit position(s) of the EMLSR Link Bitmap subfield set to 0 may be in doze state if a STA affiliated with the non-AP MLD that operates on one of the EMLSR links is in awake state.

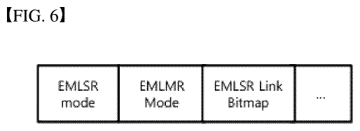

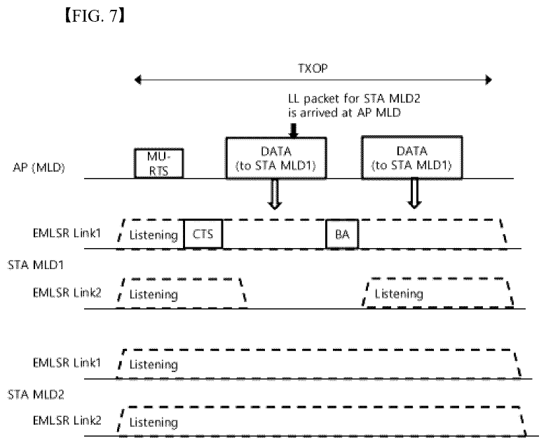

FIG. 6 shows an example of contents in EML Operating Mode Notification frame.

The EML Operating Mode Notification frame is used to indicate that a non-AP MLD with which the transmitting STA is affiliated is changing its EML operation.

A non-AP MLD that supports EMLSR operation sets the EMLSR Mode subfield to 1 to indicate that the non-AP MLD operates in EMLSR mode and to 0 to indicate that the non-AP MLD does not operate in EMLSR mode. The EMLSR Mode subfield is set to 0 if the enhanced multi-link multi-radio (EMLMR) Mode subfield is set to 1. An AP MLD that receives an EML Operating Mode Notification frame from a STA affiliated with a non-AP MLD sets the EMLSR Mode subfield of the EML Operating Mode Notification frame that is sent in response to the value obtained from the received EML Operating Mode Notification frame.

The EMLSR Link Bitmap subfield indicates the subset of the enabled links that is used by the non-AP MLD in the EMLSR mode. The bit position i of the EMLSR Link Bitmap subfield corresponds to the link with the Link ID equal to i and is set to 1 to indicate that the link is used by the non-AP MLD for the EMLSR mode and is a member of the EMLSR links; otherwise the bit position is set to 0.

When a non-AP MLD intends to operate in the EMLSR mode on the EMLSR links, a STA affiliated with the non-AP MLD can transmit an EML Operating Mode Notification frame with the EMLSR Mode subfield of the EML Control field of the frame set to 1 to an AP affiliated with an AP MLD. An AP affiliated with the AP MLD that received the EML Operating Mode Notification frame from the STA affiliated with the non-AP MLD can transmit an EML Operating Mode Notification frame to one of the STAs affiliated with the non-AP MLD within a timeout interval.

When a non-AP MLD is operating in the EMLSR mode with an AP MLD supporting the EMLSR mode, the non-AP MLD can be able to listen on the EMLSR links, by having its affiliated STA(s) corresponding to those links in awake state. The listening operation includes CCA and receiving the initial Control frame of frame exchanges that is initiated by the AP MLD. An AP affiliated with the AP MLD that initiates frame exchanges with the non-AP MLD on one of the EMLSR links can begin the frame exchanges by transmitting the initial Control frame to the non-AP MLD. The initial Control frame may be a MU-RTS Trigger frame or a BSRP Trigger frame. A STA affiliated with a non-AP MLD that is in the listening operation and that receives an MU-RTS Trigger Frame or BSRP Trigger frame addressed to it can respond except when the frame exchanges initiated by the initial Control frame on one of the EMLSR links overlaps with group addressed frame transmissions on the other EMLSR link where the non-AP STA intends to receive the group addressed frames.

After receiving the initial Control frame for initiating frame exchanges and transmitting an immediate response frame as a response to the initial Control frame, a STA affiliated with the non-AP MLD that was listening on the corresponding link can be able to transmit or receive frames on the link in which the initial Control frame was received and cannot transmit or receive on the other EMLSR link(s) until the end of the frame exchanges. The STA affiliated with the non-AP MLD can be capable of receiving a PPDU that is sent using more than one spatial stream on the link in which the initial Control frame was received a SIFS after the end of its response frame transmission solicited by the initial Control frame. During the frame exchanges, the other AP(s) affiliated with the AP MLD may not transmit frames to the other STA(s) affiliated with the non-AP MLD on the other EMLSR link(s).

The AP affiliated with the AP MLD can transmit before the TXNAV timer expires another initial Control frame addressed to the STA affiliated with the non-AP MLD if the AP intends to continue the frame exchanges with the STA and did not receive the response frame from this STA for the most recently transmitted frame that requires an immediate response after a SIFS.

Only one STA affiliated with the non-AP MLD that is operating on one of the EMLSR links may initiate frame exchanges with the AP MLD.

Transmission opportunity (TXOP) is an interval of time during which a particular STA has the right to initiate frame exchange sequences onto a wireless medium (WM) or a channel. A TXOP holder is a STA that has either been granted a TXOP or successfully contended for a TXOP. A TXOP responder is a STA that transmits a frame in response to a frame received from a TXOP holder during a frame exchange sequence, but that does not acquire a TXOP in the process.

A low latency (LL) packet may be a data unit to be transmit with minimal delay by an LL STA. The LL STA is the STA with LL packet to be transmitted. A LL packet may be a data unit arrived to the LL STA in the middle of TXOP. The LL STA may be TXOP holder or TXOP responder. In some scenarios, the LL STA may be neither TXOP holder nor TXOP responder. An LL packet may be called as various term such as high priority packet, buffered packet, enqueued packet, LL traffic, LL data, prioritized packet, etc.

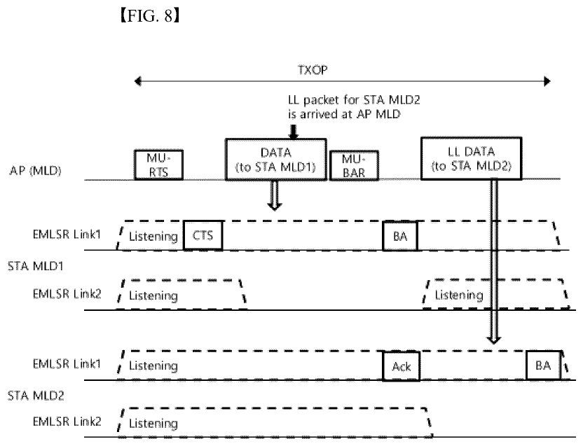

FIG. 7 shows an example illustrating problems that may occur in conventional WLAN.

AP MLD is a TXOP holder and STA MLD1 is a TXOP responder. LL packet for STA MLD2 is arrived (or is enqued) at AP MLD. However, the LL packet cannot be transmitted until the end of the TXOP. LL packet transmission is delayed to a next TXOP.

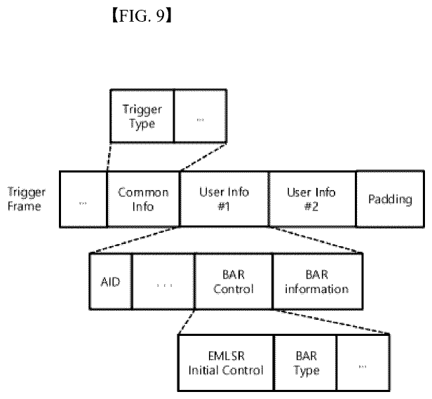

FIG. 8 shows an example of packet transmission according to an embodiment of the present disclosure.

AP MLD is a TXOP holder and STA MLD1 is a TXOP responder. When LL packet for STA MLD2 which is not TXOP responder is arrived at AP MLD, the AP MLD can send an initial control frame to STA MLD1 and STA MLD2 in the middle of TXOP. When a TXOP holder has LL packet intended to a non-TXOP responder, the TXOP holder can send a initial control frame to a TXOP responder and the non-TXOP responder in the middle of TXOP.

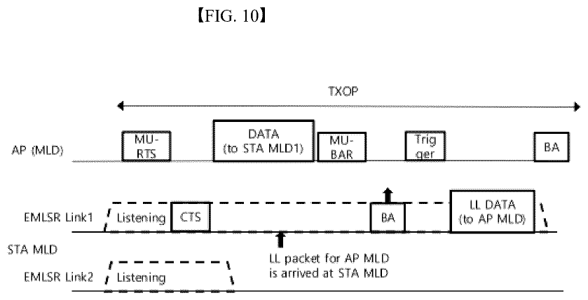

FIG. 9 shows an example of initial control frame format according to an embodiment of the present disclosure.

The initial control frame may be a MU-BAR trigger frame. When an AP affiliated with an AP MLD sends a MU-BAR Trigger frame within a TXOP, the MU-BAR Trigger frame may include a STA affiliated with STA MLDs operating on the EMLSR links in the User Info fields of the MU-BAR Trigger frame. For example, User Info #1 indicates STA MLD1 and User Info #2 indicates STA MLD2.

The Trigger Type subfield identifies a trigger frame variant. For example, the trigger frame is a MU-BAR trigger frame when the Trigger Type subfield is set to two.

The AID subfield identifies a STA which received the MU-BAR trigger frame. The BlockAckReq (BAR) Type subfield indicates the MU-BAR trigger frame variant. The meaning of the BAR Information field of the MU-BAR trigger frame depends on the MU-BAR trigger frame variant type.

The Padding field is optionally present in a trigger frame to extend the frame length to give the recipient STAs enough time to prepare a response for transmission a SIFS after the frame is received. The Padding field, if present, is at least two octets in length and is set to all 1 s. Padding field can meet the EMLSR Padding Delay required by the STA MLD.

After receiving the MU-RTS Trigger frame, the STA1 that is indicated in the User Info #1 can send the BlockAck (BA) frame in a response to the MU-BAR Trigger frame and the STA2 that is indicated in the User Info #2 can send the Ack frame (or QoS Null frame) in a response to the MU-BAR Trigger frame. The STA2 may be operating on the EMLSR link.

The MU-BAR Trigger frame can be used as an initial control frame within the TXOP in order to initiate an LL packet delivery to the STA MLD operating on the EMLSR mode.

An ELMSR Initial Control subfield can be used to indicate whether the MU-BAR Trigger frame is the initial control frame for the STA operating in the EMLSR link. The ELMSR Initial Control subfield can be used to indicate that the indicated STA which is not the TXOP responder is a temporary recipient for the LL packet within the TXOP. The ELMSR Initial Control subfield may be included in the BAR Control field. The ELMSR Initial Control subfield may have one bit. The ELMSR Initial Control subfield may be called as various term such as initial control subfield, LL packet subfield, temporary subfield, etc. The ELMSR Initial Control subfield is may be included in any field of a Trigger frame. The ELMSR Initial Control subfield may be set to one (or zero) to indicate that the User Info field in the MU-BAR Trigger frame is the initial control frame for the STA operating in the EMLSR link.

The STA identified by the User Info field having the ELMSR Initial Control subfield equal to one can send Ack frame (or QoS Null frame) as a response to the initial control frame of the EMLSR operation.

When the EMLSR Initial Control subfield in the BAR Control subfield in the User Info subfield for the MU-BAR Trigger frame is set to one, the BAR Type field may be set to two (Compressed) for backward compatibility with HE STA. The BAR Information can be reserved.

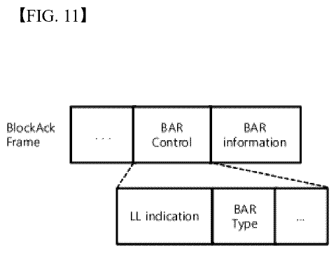

FIG. 10 shows an example of packet transmission according to another embodiment of the present disclosure.

A STA MLD can send a BA frame to acknowledge the data received from an AP MLD within a TXOP. During a TXOP, when a LL packet intended for AP MLD is arrived at STA MLD, the STA MLD can indicate the presence of the LL packet in the BA frame. A TXOP responder can indicate the presence of the LL packet intended for a TXOP holder by using a control response frame such as the BA frame. The BA frame can be used to request AP MLD to allocate resources for LL packet within the TXOP. The BA frame can be used to request AP MLD to send a trigger frame for LL packet within the TXOP.

When the STA MLD receives a trigger frame, the STA MLD can send the LL packet based on the resource allocation in the trigger frame. The LL packet can be transmitted in a TB PPDU.

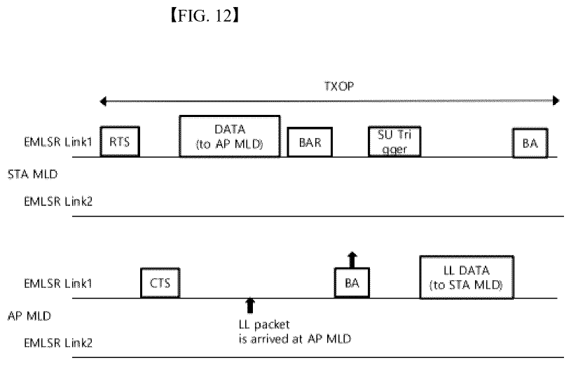

FIG. 11 shows an example of BlockAck frame format according to an embodiment of the present disclosure.

The BA frame can include an LL indication subfield to indicate the presence of the LL packet. During a TXOP, if an LL packet is arrived at a STA MLD, the STA MLD can indicate the presence of the LL packet in the BA Control field in the BA frame which is a control response frame.

The BA Control field may include the LL Indication subfield which can indicate whether the LL packet is arrived at a STA MLD. The LL indication subfield can have one bit. For example, the LL indication subfield may be set to one (or zero) when the LL packet is present.

When an AP MLD receives a BA frame in which the LL Indication subfield is set to one, the AP MLD can send a Trigger frame to the STA MLD. Otherwise, the AP MLD cannot schedule additional frame transmission to the STA MLD. Therefore, other STA on operating on the EMLSR links is able to access the wireless medium through the EDCA mechanism after switching back to listen operation.

FIG. 12 shows an example of packet transmission according to still another embodiment of the present disclosure.

During a TXOP, if a LL packet is arrived at AP MLD, the AP MLD can indicate the presence of the LL packet in the BA frame. A TXOP responder (AP MLD) can indicate the presence of the LL packet intended for a TXOP holder (STA MLD) by using a control response frame such as the BA frame.

During a TXOP, if a LL packet is arrived at an AP MLD, the AP MLD can indicate the presence of the LL in the BA Control field in the Block Ack frame as shown in FIG. 11. For example, the LL indication subfield may be set to one if a LL is arrived at an AP MLD.

When a STA MLD receives a BA frame in which the LL Indication subfield is set to one, the STA MLD can send a SU Trigger frame to the AP MLD. Otherwise, the STA MLD can stop the uplink frame transmission to the AP MLD. The STA MLD switches back to listening operation. And, the AP MLD is able to initiate a downlink frame transmission to the STA MLD.

In response to the SU Trigger frame, the AP MLD can send LL DATA to the STA MLD. The LL DATA can be transmitted as SU PPDU. In response to the LL DATA, the STA MLD can send BA frame to acknowledge the LL DATA.

When the STA MLD sends a SU Trigger frame to the AP MLD, the SU Trigger frame is used for soliciting the SU PPDU transmission (not TB PPDU transmission) from the AP MLD. The AID subfield in the User Info field in the SU Trigger frame may be set to a specific value (i.e., 0) if the AP corresponds to the transmitted BSSID or the AP is not a member of the multiple BSSID set. The AID subfield in the User Info field in the SU Trigger frame is set to an BSSID Index if the AP corresponds to the non-transmitted BSSID. If the STA MLD does not receive an immediate response of the SU Trigger frame from the AP MLD, the STA MLD can switch back to listening operation and follow the backoff procedure.

When the STA MLD sends a SU Trigger frame to the AP MLD, the SU Trigger frame also can be used for transferring the TXOP ownership to the AP MLD. On this purpose, the User Info field in the SU Trigger frame may include an Allocation Duration field which indicates whether single SU PPDU transmission is granted or multiple SU PPDU transmission is granted. For example, if the Allocation Duration field is set to 0, single SU PPDU transmission from the AP MLD is granted. If the Allocation Duration field is set to a non-zero value, multiple SU PPDU transmission from the AP MLD is granted for the Allocation Duration time. (i.e., the AP MLD has the TXOP ownership.)

FIG. 12 shows the example when single SU PPDU transmission is granted.

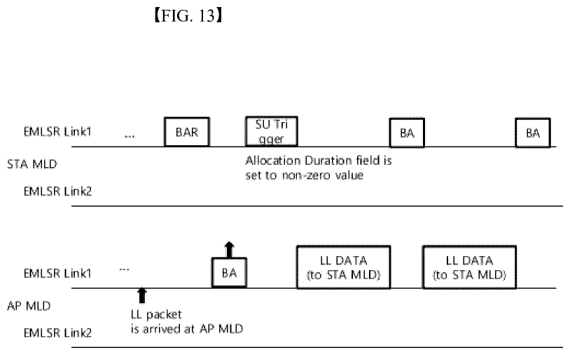

FIG. 13 shows an example when multiple SU PPDU transmission is granted.

After the STA MLD sends a SU Trigger frame which grants multiple SU PPDU transmission to the AP MLD, the STA MLD may stay awake state for receiving the frame exchange from AP MLD. The Allocation Duration field in the SU Trigger frame may be set to a non-zero value to indicate that the multiple SU PPDU transmission is granted. The STA MLD may stay awake state fro a predefined time.

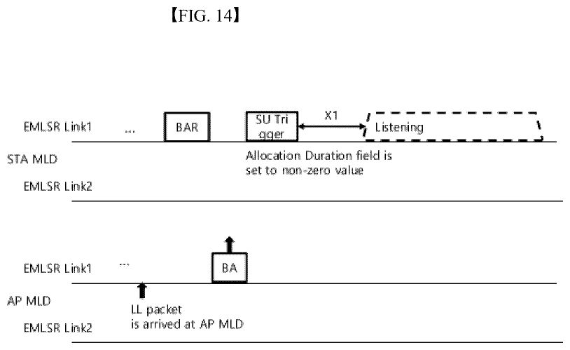

FIG. 14 shows another example when multiple SU PPDU transmission is granted.

The STA MLD may stay awake state for receiving the frame exchange from AP MLD unless the MAC of the STA affiliated with the non-AP MLD that transmitted the SU Trigger frame does not receive a PHY-RXSTART.indication primitive during a timeout interval of ‘X1’ starting at the end of the PPDU containing the SU Trigger frame. X1 can be defined as aSIFSTime+aSlotTime+aRxPHYStartDelay.

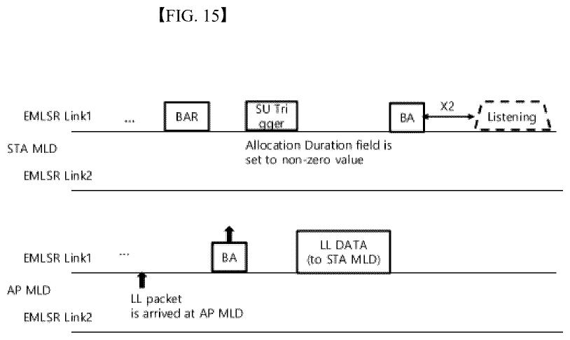

FIG. 15 shows still another example when multiple SU PPDU transmission is granted.

The STA MLD may stay awake state for receiving the frame exchange from AP MLD unless the MAC of the STA affiliated with the non-AP MLD that transmitted the SU Trigger frame does not receive a PHY-RXSTART.indication primitive during a timeout interval of ‘X2’ starting at the end of the PPDU transmitted by the STA affiliated with the non-AP MLD as a response to the most recently received frame from the AP affiliated with the AP MLD or starting at the end of the reception of the PPDU containing a frame for the STA from the AP affiliated with the AP MLD that does not require immediate acknowledgement. X2 can be defined as aSIFSTime+aSlotTime+aRxPHYStartDelay.

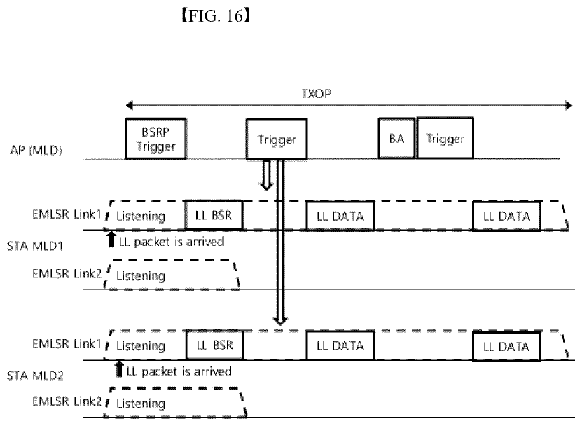

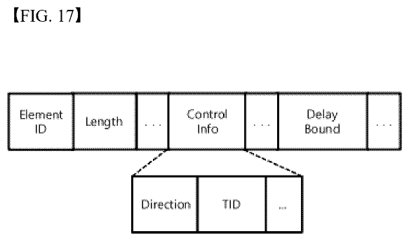

FIG. 16 shows an example of packet transmission according to an embodiment of the present disclosure.

AP MLD is a TXOP holder and at least one of STA MLD1 and STA MLD2 is a TXOP responder. A buffer status report poll (BSRP) trigger frame is used to solicit buffer status report (BSR). A non-AP STA can deliver BSRs to assist its AP in allocating UL MU resources. BSR can include one or more QoS Null frames containing at least one QoS Control field with buffer status and/or at least one BSR Control subfield with buffer status.

When an AP affiliated with an AP MLD sends the BSRP Trigger frame within a TXOP, the BSRP Trigger frame may include LL BSRP information in the User Info field of the BSRP Trigger frame. For example, User Info #1 indicates a regular BSRP and User Info #2 indicates an LL BSRP. Padding field can meet the EMLSR Padding Delay required by the STA MLD.

After receiving the BSRP Trigger frame, the STA MLD1 indicated in the User Info #1 can send the LL BSR frame in a response of the BSRP Trigger frame. The STA MLD2 indicated in the User Info #2 can send the LL BSR frame in a response of the BSRP Trigger frame. It is noted that the STA MLD1 and STA MLD2 may operate on the EMLSR link. In such case the BSRP Trigger frame is used as the initial control frame in the EMLSR operation.

For the regular BSRP, if the STA MLD1 having a LL packet is trigged by the regular BSRP, the STA MLD1 can send the LL BSR by using the resources allocated by the BSRP Trigger frame. The STA MLD1 can send the LL BSR on the resource unit indicated by the RU Allocation subfield of the regular BSRP.

Table 1 shows a format of QoS Control field included in BSR.

TABLE 1

| Bits 0-3 | Bit 4 | Bits 5-6 | Bit 7 | Bits 8-15 |
|---|---|---|---|---|
| TID | 1 | Ack Policy | LL BSR | Delay Time |
| | | Indicator | | |

For LL BSR frame format, the traffic identifier (TID) subfield in the QoS Control field is set to a pre-determined value (e.g., 14) to indicate the LL BSR. Or, the bit 7 in the QoS Control field is defined as the LL BSR subfield to indicate the LL BSR.

In the LL BSR frame, the bits 8-15 may be represented as the Delay Time subfield. The Delay Time subfield can indicate the time margin that can be waited until the scheduling, to meet the delay bound of the buffered MSDUs. The Delay Time subfield set to a negative value can indicate that the MSDU is not buffered as of now but it is expected to arrive after the delay time. This is useful when the LL packet arrives with a periodic pattern and a small delay jitter.

For the LL BSRP frame, AID12 subfield of the User Info field is set to a predetermined value (e.g., 2044). The RU Allocation subfield represents the resource unit information which is used to send the LL BSR frame. If the RU Allocation indicates ‘single resource unit’, one or more STA having LL packet may send the LL BSR frame with the common format on the corresponding resource unit. The common format can be either a CTS frame or an Ack frame. Since the AP does not figure out which STA sends the LL BSR, the AP can send another BSRP Trigger frame or the NDP feedback report poll (NFRP) Trigger frame after receiving the LL BSR frame. When the NFRP Trigger frame is used to the LL report, the Feedback Type subfield can be set to 1 (0: Resource Request, 1: LL Resource Request). If the Feedback Type subfield in the User Info field of the NFRP Trigger frame is 1, a STA having LL packet in its queues may send an NDP feedback report response.

For the LL BSRP frame, AID12 subfield of the User Info field is set to a predetermined value (e.g., 2044). The RU Allocation subfield represents the resource unit information which is used to send the LL BSR. If the RU Allocation indicates ‘multiple resource units’, one or more STA having LL packet may send the LL BSR frame having the LL information and the identifier of the STA through the OFDMA random access on the resource units indicated by the RU Allocation subfield. In the OFMDA random access, STA(s) that are eligible to participate in the OFDMA random access choose one of the resource units specified by the RU Allocation and they send the LL BSR frame. Otherwise, the STA(s) do not send the LL BSR frame on the resource units indicated by the LL BSRP. If the RU Allocation doe not indicates multiple resource units, the STA may not send any LL BSR on the resource units indicated by the LL BSRP.

If the STA has a LL packet and is also trigged by the regular BSRP, the STA can send the LL BSR frame on the resource unit indicated by the RU Allocation subfield of the regular BSRP, not using the resource unit(s) indicated by the LL BSRP.

In the embodiments described in this disclosure, an TXOP holder and a TXOP responder (and/or a non-TXOP responder) can negotiate LL support before a TXOP starts or during the TXOP. An AP and non-AP STA can negotiate LL support before a TXOP starts or during the TXOP. This negotiation can be performed by using a stream classification service (SCS) procedure which is used by a non-AP MLD to request an AP MLD to classify incoming individually addressed MSDUs based on parameters provided by the non-AP MLD and/or describe its traffic characteristics to an AP MLD. For example, a STA that needs LL support may send a frame containing a QoS Characteristics element.

FIG. 17 shows an example of QoS Characteristics element format.

The QoS Characteristics element contains a set of parameters that define the characteristics and QoS expectations of a traffic flow.

The Direction subfield in the Control Info field specifies the direction of data. For example, the Direction subfield is set to 0 to indicate Uplink, the Direction subfield is set to 1 to indicate Downlink, and the Direction subfield is set to 2 to indicate Direct link.

The Delay Bound field contains an unsigned integer that specifies the maximum amount of time, in microseconds, allowed to transport an MSDU or A-MSDU belonging to the traffic flow described by this element. The maximum amount of time can be measured between the time marking the arrival of the MSDU, or the first MSDU of the MSDUs constituting an A-MSDU, at the local MAC sublayer from the local MAC SAP and the time of completion of the successful transmission or retransmission of the MSDU or A-MSDU to the destination. The completion time of the MSDU or A-MSDU transmission includes the corresponding acknowledgment frame transmission time. If the Direction subfield is set to 0 (Uplink) or 2 (Direct link), the value 0 indicates that this parameter is unspecified. If the Direction subfield is set to 1 (Downlink), the value 0 is reserved.

For the LL BSRP frame, AID12 subfield of the User Info field is set to a predetermined value (e.g., 2044). In a first embodiment, each STA that needs LL support may send a frame containing the QoS Characteristics element shown in FIG. 17, which declares the expected Delay Bound, to the AP. The RU Allocation subfield in the LL BSRP in the BSRP Trigger frame indicates multiple resource units, and one Delay Bound Margin (different eligibility criteria can be chosen) is signaled by the LL BSRP in the BSRP Trigger frame.

If the time to meet the Delay Bound is less than the Delay Bound Margin value specified in the LL BSRP, the STA is eligible to participate in the OFDMA random access. Otherwise, the STA is not eligible to participate in the OFDMA random access. A STA1 that declared the Delay Bound to 200 microseconds has a MSDU that can't meet 200 microseconds delay bound requirement after 30 microseconds. A STA2 that declared the Delay Bound to 100 microseconds has a MSDU that can't meet 100 microseconds delay bound requirement after 70 microseconds. If the STA receives the BSRP Trigger that contains the LL BSRP with a Delay Bound Margin equal to 50 microseconds, only STA1 is eligible to participate in the OFDMA random access.

For the LL BSRP, AID12 subfield of the User Info field is set to a pre-determined value (e.g., 2044). In a second embodiment, each STA that needs LL support may send a frame containing the QoS Characteristics element shown in FIG. 17, which declares the expected Delay Bound, to the AP. The RU Allocation indicates multiple resource units, and two Delay Bound Margins (different eligibility criteria can be chosen) are signaled by the LL BSRP in the BSRP Trigger frame.

If the time to meet the Delay Bound is less than first Delay Bound Margin value specified in the LL BSRP, the STA is eligible to participate in the OFDMA random access with the first random access parameter. Else if the time to meet the Delay Bound is greater than first Delay Bound Margin value and less than second Delay Bound Margin value specified in the LL BSRP, the STA is eligible to participate in the OFDMA random access with the second random access parameter. Otherwise, the STA is not eligible to participate in the OFDMA random access. A STA1 that declared the Delay Bound to 200 microseconds has a MSDU that can't meet 200 microseconds delay bound requirement after 30 microseconds. A STA2 that declared the Delay Bound to 100 microseconds has a MSDU that can't meet 100 microseconds delay bound requirement after 70 microseconds. If the STA receives the BSRP Trigger that contains the LL BSRP with a first Delay Bound Margin equal to 50 microseconds and a second Delay Bound Margin equal to 100 microseconds, STA1 is eligible to participate in the OFDMA random access with the first random access parameter and STA2 is eligible to participate in the OFDMA random access with the second random access parameter. The first random access parameter and second random access parameter may work on different/disjoint resource units.

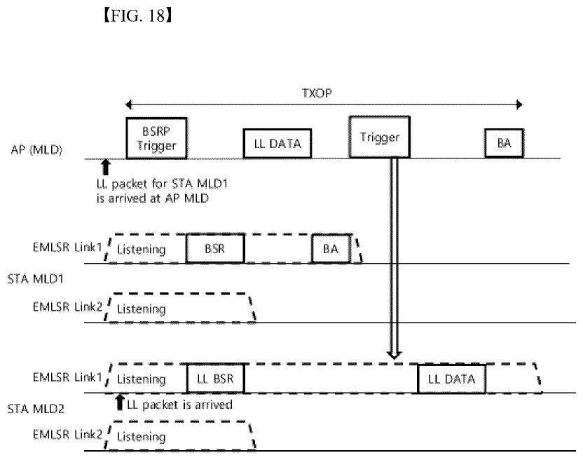

FIG. 18 shows an example of packet transmission according to another embodiment of the present disclosure.

An AP affiliated with an AP MLD has LL packet for STA MLD1, but the AP cannot immediately schedule an uplink resource to an STA MLD2 having LL packet for AP. In such case, the AP MLD needs to indicate that the STA MLD2 operating in the EMLSR mode does not switch back to the listening operation even though the STA MLD2 does not receive any frame. And the STA MLD2 needs to stay during the remaining TXOP.

On this purpose, the BSRP Trigger frame can include an LL EMLSR subfield to indicate that the STA operating in the EMLSR mode stays on the current link during the remaining TXOP. B30 in the SS Allocation subfield in the User Info field in BSRP Trigger frame is utilized as the LL EMLSR subfield. For example, if the LL EMLSR subfield in the received BSRP Trigger frame is set to a value (e.g. 1), the STA MLD operating in the EMLSR mode can stay on the current link during the remaining TXOP. Otherwise, the STA MLD can switch back to the listening operation on the EMLSR links when the STA MLD does not receive any frame.

The BSRP Trigger frame can further include a DL Indicator subfield to indicate that the AP has any buffered DL frames addressed to the STA. If the LL EMLSR subfield is included in the BSRP Trigger frame, the DL Indicator subfield can also be included in the BSRP Trigger frame. B31 in the SS Allocation subfield in the User Info field in BSRP Trigger frame is utilized as the DL Indicator subfield. If the LL EMLSR subfield in the received BSRP Trigger frame is set to 1, B31 in the SS Allocation subfield in the User Info field in BSRP Trigger frame is defined as the DL Indicator subfield. When the AP MLD has any buffered DL frames addressed to the STA MLD, the DL Indicator subfield in the BSRP Trigger frame is set to a first value (e.g. 1). Otherwise it is set to a second value (e.g. 0).

If the STA MLD receives the BSRP Trigger frame whose User Info field is addressed to the STA MLD and whose DL Indicator subfield of the corresponding User Info field is set to 0, the STA MLD may discard the BSRP Trigger frame (i.e., the STA MLD does not send the BSR) and continue on the listening operation on the EMLSR links (i.e., the STA MLD does not leave the EMLSR listening operation) unless the STA MLD has any frame destined to the AP MLD.

Since the number of spatial streams for the response to the BSRP Trigger frame in in the EMLSR operation can be limited to one, a part of the SS Allocation subfield in the BSRP Trigger frame can be utilized to define LL EMLSR subfield and DL Indicator subfield.

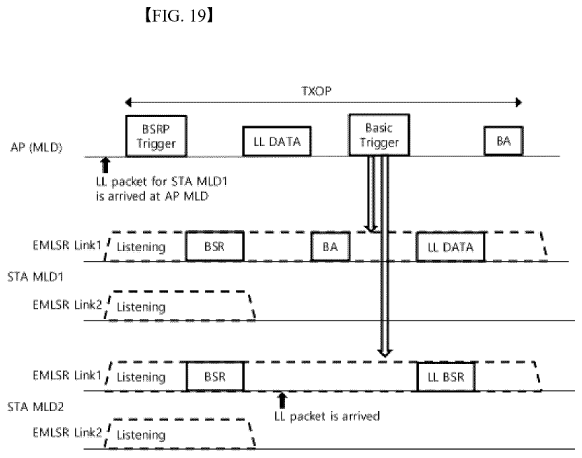

FIG. 19 shows an example of packet transmission according to still another embodiment of the present disclosure.

When an AP affiliated with an AP MLD sends the Basic Trigger frame within a TXOP, the Basic Trigger frame may include LL BSRP information in the User Info field. For example, User info #1 indicate basic trigger, and User info #2 indicate LL BSRP. Padding field may be present to meet the EMLSR Padding Delay required by the STA MLD.

After receiving the Basic Trigger frame, the STA MLD1 indicated in the User Info #1 may send the TB PPDU carrying the data (if STA MLD1 has LL packet for AP, the LL packet is included in the TB PPDU) in a response of the Basic Trigger frame. The STA MLD2 indicated in the User Info #2 can send the LL BSR frame in a response of the Basic Trigger frame. It is noted that the STA MLD1 and STA MLD2 may operate on the EMLSR link. In such case the Basic Trigger frame can be used as the initial control frame in the EMLSR operation.

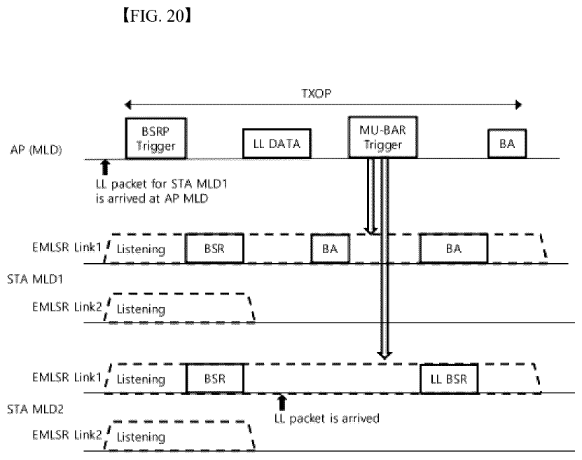

FIG. 20 shows an example of packet transmission according to still another embodiment of the present disclosure.

When an AP affiliated with an AP MLD sends the MU-BAR Trigger frame within a TXOP, the MU-BAR Trigger frame may include LL BSRP information in the User Info field. For example, User info #1 indicate Block Ack Request, and User info #2 indicate LL BSRP. Padding field may be present to meet the EMLSR Padding Delay required by the STA MLD.

After receiving the MU-BAR Trigger frame, the STA MLD1 indicated in the User Info #1 can send the BA frame in a response of the MU-BAR Trigger frame. The STA MLD2 indicated in the User Info #2 can send the LL BSR frame in a response of the MU-BAR Trigger frame. It is noted that the STA MLD1 and STA MLD2 may operate on the EMLSR link. In such case the MU-BAR Trigger frame can be used as the initial control frame in the EMLSR operation.

Hereinafter, how to support MSDU reordering for LL application is proposed.

The Medium Access Control (MAC) may provide various services such as the reordering of MAC service data units (MSDUs), etc. In a non-QoS STA, the MAC does not intentionally reorder MSDUs except as might be necessary to improve the likelihood of successful delivery based on the current operational mode of the designated recipient STA(s). The effect of this reordering, for the set of MSDUs received at the MAC service interface of any single STA, may be a change in the delivery order of group addressed MSDUs, relative to individually addressed MSDUs, originating from a single source STA address.

The MSDUs are reordered, not only to improve the likelihood of successful delivery based on the current operational mode of the designated recipient STA(s), but also to honor the priority parameters of the individual MSDUs. The effects of this reordering, for the set of MSDUs received at the MAC service interface of any single STA, are: (i) a change in the delivery order of group addressed MSDUs, relative to individually addressed MSDUs, and (ii) the reordering of MSDUs with different TID values, originating from a single source STA address.

When MSDU or A-MSDU reordering is performed, the information in the MAC service tuple(s) for the MSDU(s) can be maintained and reordered as a unit. A TID is any of the identifiers usable by higher layer entities to distinguish MSDUs to MAC entities that support QoS within the MAC data service.

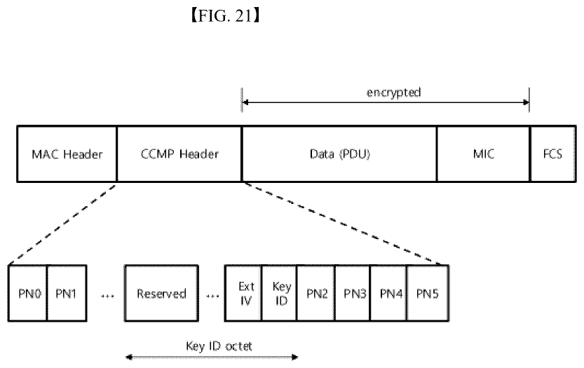

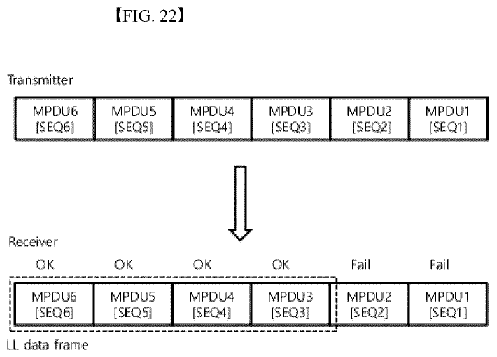

FIG. 21 shows an example of CCMP MPDU format.

CTR with CBC-MAC protocol (CCMP)) specifies variants of CCMP, which provides data confidentiality, authentication, integrity, and replay protection. CCMP is based on the CCM of the AES encryption algorithm. CCM combines Counter Mode (CTR) for data confidentiality and CBC-MAC for authentication and integrity. CCM protects the integrity of both the MPDU Data field and selected portions of the IEEE 802.11 MPDU header.

The CCMP Header field is constructed from the PN, ExtIV, and Key ID subfields. A packet number (PN) is a 48-bit PN represented as an array of 6 octets. PN5 is the most significant octet of the PN, and PN0 is the least significant. The PN is incremented by a positive number for each MPDU.

To effect replay detection, the receiver extracts the PN from the CCMP header. The following processing rules are used to detect replay:
(i) The receiver maintains a separate set of replay counters for each PTKSA, TPKSA, GTKSA, protocol version value, mesh PTKSA, and mesh GTKSA. The receiver initializes these replay counters to 0 when it resets the temporal key for a peer. The replay counter is set to the PN value of accepted CCMP MPDUs.
(ii) For each PTKSA, TPKSA, GTKSA, protocol version value, mesh PTKSA, and mesh GTKSA, the recipient maintains a separate replay counter for each TID, subject to the limitation of the number of supported replay counters indicated in the RSN Capabilities field, and uses the PN from a received frame to detect replayed frames. A replayed frame occurs when the PN from a received frame is less than or equal to the current replay counter value for the frame's MSDU or A-MSDU priority and frame type.
(iii) The receiver discards any Data frame that is received with its PN less than or equal to the value of the replay counter that is associated with the TA and priority value of the received MPDU. The receiver discards MSDUs and MMPDUs whose constituent MPDU PN values are not incrementing in steps of 1. If the receiver set the MFPC bit on a given link to 1, the receiver discards any individually addressed robust Management frame that is received with its PN less than or equal to the value of the replay counter associated with the TA of that individually addressed Management frame.
(iv) For MSDUs or A-MSDUs sent using the block ack feature, reordering of received MSDUs or A-MSDUs according to the block ack receiver operation is performed prior to replay detection.

FIG. 22 shows an example of Head-of-line (HOL) blocking issue.

When multiple traffic is multiplexed to a single TID, if head-of-line (HOL) frame is failed, successfully received other frames can't be also processed.

For example, because the MPDU1 and MPDU2 failed, the MPDU3 to MPDU6 can't be processed by the upper layer even though the traffic flow is different with MPDU1 and MPDU2 (i.e., reordering is acceptable).

Because the MPDUs having the same TID is sharing the same replay counter. After delivering the MPDU3 to MPDU6 to the upper layer, if the receiver updates the replay counter to the PN of the MPDU6, the retransmitted MPDU1 and MPDU2 will be discarded as replayed frames. And, if the receiver does not update the replay counter after delivering the MPDU3 to MPDU6 to the upper layer, when the MPDU3 to MPDU6 are replayed by the attacker, the receiver can't discard them.

In order to address a HOL blocking issue, the MPDUs containing LL packet are encrypted with the separate PN sequence for LL application. The MAC header and/or CCMP header may include information (i.e. a field) to indicate the MPDU contains the LL packet and the MPDU is encrypted with the separate PN sequence for LL application.

The receiver also maintains the separate Replay Counter for LL application. If the receiver determines that the received MPDU contains LL packet, the receiver can process and deliver it to the upper layer before receiving all preceding MPDUs if the expedited processing is permitted by the source or destination.

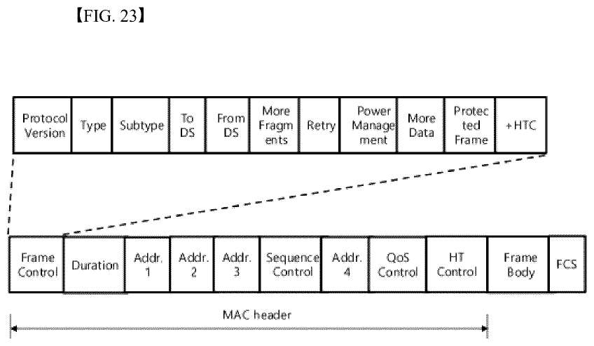

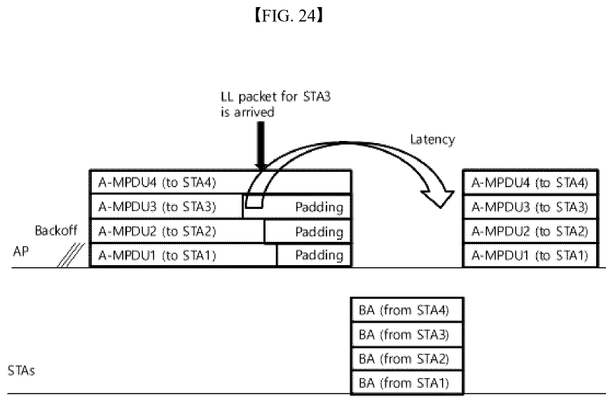

FIG. 23 shows MAC frame format to classify LL MPDU according to an embodiment of the present disclosure.

For normal data, the Type subfield (B3 B2) in the Frame Control field is set to 01. And, the Subtype subfield (B7 B6 B5 B4) in the Frame Control field is set to 0000.

For LL Data, the Type subfield (B3 B2) in the Frame Control field is set to 01. And, the Subtype subfield (B7 B6 B5 B4) in the Frame Control field is set to ‘0001’.

If a frame is a LL Data frame, the QoS Control field may have the following format as shown in Table 2. Field names and number of bits are exemplary purpose only.

TABLE 2

| Field | | Expedited | | Ack Policy | A-MSDU | LL Queue |
|---|---|---|---|---|---|---|
| Name | LL TID | Processing | EOSP | Indicator | Present | Size |
| Num. of Bits | 4 | 1 | 1 | 1 | 1 | 8 |

A Low Latency TID subfield may indicate the TID and/or SCSID of the low latency traffic Flow. The stream classification service (SCS) identifier (SCSID) is a nonzero value chosen by the non-AP STA identifying the SCS stream. An Expedited Processing subfield may indicate whether the receiver can immediately process the LL packet and deliver to the upper layer even though at least one of the preceding MPDUs is not been successfully received yet. A LL Queue Size field may indicate the Queue Size of the LL.

As another embodiment to classify LL MPDU, an LL subfield to indicate that the LL packet is contained can be defined in the CCMP Header. For example, first bit (B0) of Key ID octet can be used as the LL subfield. The LL subfield can be set to a first value (e.g. 1) if the Data contains the LL packet. Otherwise, the LL subfield is set to a second value (e.g. 0).

An Expedited Processing subfield can be defined in the CCMP Header. The Expedited Processing subfield can indicate whether the receiver can immediately process the encrypted MPDU containing LL packet and deliver to the upper layer even though at least one of the preceding MPDUs is not been successfully received yet. For example, second bit (B1) of Key ID octet can be used as the Expedited Processing subfield.

As still another embodiment to classify LL MPDU, BlockAckReq frame and/or MU-BAR Trigger frame can contain an LL Data Indication subfield. As shown in FIG. 9, BlockAckReq frame and/or MU-BAR Trigger frame can include BAR control field and BAR information field. BlockAckReq frame and/or MU-BAR Trigger frame may include an LL Data Indication Present subfield in the BAR Control field and the LL Data Indication subfield in the BAR information field. For example, If the LL Data Indication Present subfield in the BAR Control field is set to 1, the BAR Information field contains the LL Data Indication subfield. The LL Data Indication subfield is the bitmap that specifies the sequence numbers of the MPDUs containing LL packets.

Hereinafter, how to construct A-MPDU for LL application is proposed.

An Aggregate-MPDU (A-MPDU) includes one or more MPDUs. A STA that transmits a PPDU that contains one or more PSDUs, each of which contains an A-MPDU, constructs the A-MPDU(s).

First, An A-MPDU pre-EOF padding is constructed for each user from any of the following: (i) A-MPDU subframes constructed from the MPDUs available for transmission that have a TID value that maps to the primary AC, and (ii) A-MPDU subframes with 0 in the MPDU Length field and 0 in the EOF field.

Second, the A-MPDU_Length[n] for user n is initialized as the length of the resulting A-MPDU pre-EOF padding.

Third, padding is then added for each user such that the resulting A-MPDU contains exactly PSDU_LENGTH octets for that user as follows.

First, while A-MPDU_Length[n]<PSDU_LENGTH [n] and A-MPDU_Length[n] mod 4≠0, add an octet to the final A-MPDU subframe's Padding subfield and increment A-MPDU_Length[n] by 1.

Then, while A-MPDU_Length[n]+4≤PSDU_LENGTH [n], add an EOF padding subframe to the EOF Padding Subframes field and increment A-MPDU_Length[n] by 4.

Finally, while A-MPDU_Length[n]<PSDU_LENGTH [n], add an octet to the EOF Padding Octets subfield and increment A-MPDU_Length[n] by 1.

FIG. 24 shows an example of constructing A-MPDU for LL application.

When an LL packet is arrived after constructing an A-MPDU, the A-MPDU may be scheduled in the following PPDU or the following TXOP. It can't replace the Padding.

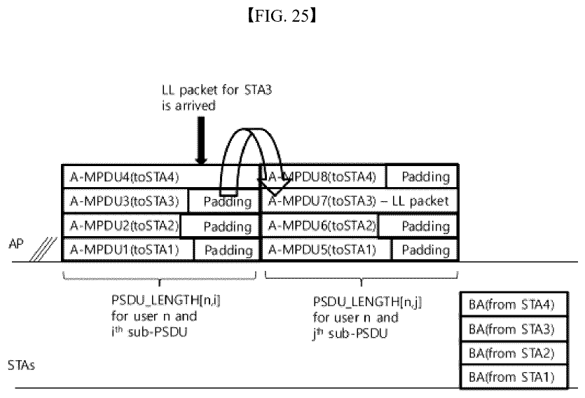

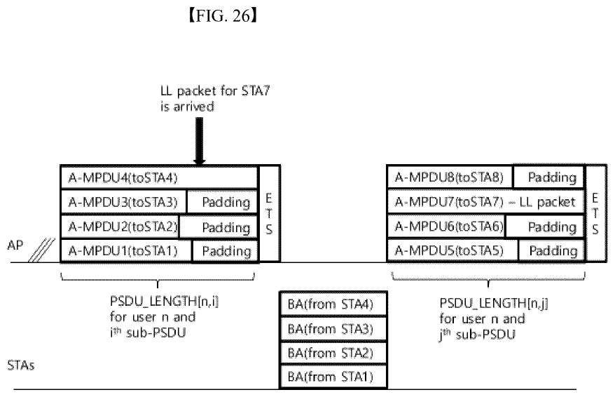

FIG. 25 shows an example of constructing A-MPDU for LL application according to an embodiment of the present disclosure.

In order to schedule the LL packet while A-MPDU is transmitted, A-MPDU construction is changed. Within a PSDU addressed to single STA, more than one A-MPDU can be present. But, the length of each A-MPDU can be shortened.

For example, referring to FIG. 25, within a PSDU destined to STA3, A-MPDU3 and A-MPDU7 are included, and independently constructed. But, the length of each A-MPDU (i.e., A-MPDU3 and A-MPDU7) is identical but can be different. The PHY/MAC header may need to specify the length information.

A-MPDU3 and A-MPDU7 have the starting and ending OFDM (A) symbol boundary alignment with A-MPDUs sent to different STA through other RUs. For A-MPDU3, the starting time of the A-MPDU3 is the same as that of A-MPDU1, A-MPDU2, and A-MPDU4. The ending time of the A-MPDU3 is the same as that of A-MPDU1, A-MPDU2, and A-MPDU4. The same EOF Padding rule is applied to A-MPDU3 and A-MPDU7. It is noted that PHY Padding is appended only after the last A-MPDU.

FIG. 25 shows an example of constructing A-MPDU for LL application.

AP can stop a transmission at the middle of the PPDU to schedule other STAs. Because the PSDU carries more than one A-MPDU and the ending time of each A-MPDU are aligned. In other words, because the ending time of sub-PSDU containing a single A-MPDU is aligned, the STA can easily stop the transmission by just adding PHY padding.

FIG. 26 shows an example of constructing A-MPDU for LL application.

In order to indicate early PPDU termination, at the end of the sub-PPDU boundary, the Early Termination Sequence (ETS) can be transmitted.

As used herein, a phrase referring to “at least one of” or “one or more of” a list of items refers to any combination of those item, including single members. For example, “at least one of: a, b, and c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

While operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1-11. (canceled)

12. A method for transmitting data in a wireless local area network, the method performed by a station (STA) and comprising:
receiving a trigger frame from an access point (AP) as an initial control frame;
determining which one of a BlockAck frame and a Buffer Status Report (BSR) frame is responded as a response to the trigger frame;
if the BlockAck frame is determined as the response to the trigger frame, transmitting the BlockAck frame to the AP as the response to the trigger frame,
wherein the BlockAck frame includes indication information indicating that the AP does not schedule for transmission any physical layer protocol data unit (PPDU) containing frames addressed to the STA.

13. The method of claim 12, wherein the AP which transmits the trigger frame is an AP affiliated with an AP multi-link device (MLD) supporting an enhanced multilink single radio (EMLSR) mode, and the STA is a non-AP STA affiliated with a non-AP MLD operating in the EMLSR mode.

14. The method of claim 13, wherein the STA transmits the BlockAck frame on a link on which the trigger frame was received.

15. The method of claim 12, wherein the AP is a transmission opportunity (TXOP) holder that acquires a TXOP, and the station is a TXOP responder.

16. The method of claim 12, wherein the trigger frame is a buffer status report poll (BSRP) trigger frame, and the BlockAck frame is determined as the response to the BSRP trigger frame.

17. A device for a wireless local area network, the device comprising:
a processor; and
a memory operatively coupled with the processor and configured to store instructions that, when executed by the processor, cause the device to perform functions comprising:
receiving a trigger frame from an access point (AP) as an initial control frame;
determining which one of a BlockAck frame and a Buffer Status Report (BSR) frame is responded as a response to the trigger frame;
if the BlockAck frame is determined as the response to the trigger frame, transmitting the BlockAck frame to the AP as the response to the trigger frame,
wherein the BlockAck frame includes indication information indicating that the AP does not schedule for transmission any physical layer protocol data unit (PPDU) containing frames addressed to the device.

18. The device of claim 17, wherein the AP which transmits the trigger frame is an AP affiliated with an AP multi-link device (MLD) supporting an enhanced multilink single radio (EMLSR) mode, and the device is a non-AP STA affiliated with a non-AP MLD operating in the EMLSR mode.

19. The device of claim 18, wherein the BlockAck frame is transmitted on a link on which the trigger frame was received.

20. The device of claim 17, wherein the AP is a transmission opportunity (TXOP) holder that acquires a TXOP, and the station is a TXOP responder.

21. The device of claim 17, wherein the trigger frame is a buffer status report poll (BSRP) trigger frame, and the BlockAck frame is determined as the response to the BSRP trigger frame.
